(19) United States
(12) Patent Application Publication
(10) Pub. No.: US 2026/0204234 A1
(43) Pub. Date: Jul. 16, 2026

(54) DISPLAY SYSTEM, CONTROL CIRCUIT AND BACKLIGHT CONTROL METHOD

(71) Applicant: NOVATEK Microelectronics Corp., Hsinchu (TW)

(72) Inventors: Yueh Ting Chen, Tainan City (TW); Chun-Hsiang Wang, Tainan City (TW); Hung-Hsiang Chen, Hsinchu City (TW)

(73) Assignee: NOVATEK Microelectronics Corp., Hsinchu (TW)

(21) Appl. No.: 19/446,938

(22) Filed: Jan. 13, 2026

Related U.S. Application Data
(60) Provisional application No. 63/744,384, filed on Jan. 13, 2025.

(51) Int. Cl. G09G 3/34; B60K 35/10; B60K 35/28; B60K 35/29; G06F 3/04817; G06F 3/0488

(52) U.S. Cl. CPC G09G 3/3426; B60K 35/10; B60K 35/28; B60K 35/29; G06F 3/04817; G06F 3/0488; B60K 2360/1438; B60K 2360/162; B60K 2360/191; G09G 2310/0237; G09G 2354/00; G09G 2360/144; G09G 2380/10

(57) ABSTRACT

Provided are a display system, a control circuit, and a backlight control method. The control circuit includes a dimming control circuit. The dimming control circuit generates backlight control data to control a brightness level of a backlight unit of a backlight panel of the display system. The brightness level of the backlight unit is increased or is made to blink based on the backlight control data in response to a touch position of a touch event occurring on a touch display panel of the display system being in a range of the backlight unit or in a range of a backlight group which the backlight unit belongs to.

### CROSS-REFERENCE TO RELATED APPLICATION

This application claims the priority benefit of US provisional application serial no. 63/744,384, filed on January 13, 2025. The entirety of the above-mentioned patent application is hereby incorporated by reference herein and made a part of this specification.

### BACKGROUND

### Technical Field

The disclosure relates to a display system, and more particularly, to a display system, a control circuit, and a backlight control method capable of providing visual feedback to an end user.

### Description of Related Art

Touch display systems are widely applied in in-vehicle systems. A driver may trigger the in-vehicle system to perform various application functions by touching a specific position on the display panel. When the driver uses the touch display panel, the touch display panel does not provide visual feedback, so the driver may not immediately knows whether the corresponding function button has been correctly touched and activated. The driver needs to repeatedly confirm whether the correct function has been touched, which distracts the driver and easily causes safety concerns.

### SUMMARY

The disclosure provides a display system, a control circuit, and a backlight control method so as to provide the driver with intuitive visual feedback by using a touch-controlled brightness enhancement function under a local dimming control architecture, thereby improving driving safety.

In an embodiment of the disclosure, the above-mentioned control circuit includes a dimming control circuit. The dimming control circuit is configured to generate backlight control data to control a brightness level of a backlight unit of a backlight panel of the display system. The brightness level of the backlight unit is increased or is made to blink based on the backlight control data in response to a touch position of a touch event occurring on a touch display panel of the display system being in a range of the backlight unit or in a range of a backlight group which the backlight unit belongs to.

In an embodiment of the disclosure, the above-mentioned backlight control method includes: generating, by a dimming control circuit of a control circuit for backlight control in a display system, backlight control data to control a brightness level of a backlight unit of a backlight panel of the display system; and increasing the brightness level of the backlight unit or making the backlight unit to blink according to the backlight control data in response to a touch position of a touch event occurring on a touch display panel of the display system being in a range of the backlight unit or in range of a backlight group which the backlight unit belongs to.

In an embodiment of the disclosure, the above-mentioned display system includes a touch display panel, a backlight panel, a backlight driver, and a control circuit. The control circuit is used for backlight control in the display system. The control circuit includes a dimming control circuit. The dimming control circuit is configured to generate backlight control data to control a brightness level of a backlight unit of the backlight panel. The brightness level of the backlight unit is increased or is made to blink based on the backlight control data in response to a touch position of a touch event occurring on a touch display panel being in a range of the backlight unit or in a range of a backlight group which the backlight unit belongs to.

Based on the above, the control circuit described in the embodiments of the disclosure may apply a local dimming control function to the backlight panel. When a touch event occurs on the touch display panel, the touch position of the touch event corresponds to one or more backlight units of the backlight panel. In some embodiments, the control circuit may increase the brightness level of the one or more backlight units corresponding to the touch position by adjusting the backlight control data. In other embodiments, the control circuit may make the brightness level of the one or more backlight units corresponding to the touch position to blink by adjusting the backlight control data. Based on this, the control circuit may utilize the touch-controlled brightness enhancement function to provide the driver with intuitive visual feedback to enhance driving safety.

In an embodiment of the disclosure, the above-mentioned control circuit includes a dimming control circuit. The dimming control circuit is configured to generate backlight control data to control a brightness level of a backlight unit of a backlight panel of the display system. The backlight unit belongs to a backlight group including a plurality of backlight units, and the backlight group corresponds to a specific image block. The brightness level of the backlight unit is increased or is made to blink based on the backlight control data while the display system is operating in a specific mode.

In an embodiment of the disclosure, the above-mentioned backlight control method includes: generating, by a dimming control circuit of a control circuit for backlight control in a display system, backlight control data to control a brightness level of a backlight unit of a backlight panel of the display system, where the backlight unit belongs to a backlight group including a plurality of backlight units, and the backlight group corresponds to a specific image block; and increasing the brightness level of the backlight unit or making the backlight unit to blink based on the backlight control data while the display system is operating in a specific mode.

In an embodiment of the disclosure, the above-mentioned display system includes a touch display panel, a backlight panel, a backlight driver, and a control circuit. The control circuit is used for backlight control in the display system. The control circuit includes a dimming control circuit. The dimming control circuit is configured to generate backlight control data to

control a brightness level of a backlight unit of a backlight panel of the display system, where the backlight unit belongs to a backlight group including a plurality of backlight units, and the backlight group corresponds to a specific image block. The brightness level of the backlight unit is increased or is made to blink based on the backlight control data while the display system is operating in a specific mode.

Based on the above, the control circuit described in the embodiments of the disclosure may apply a local dimming control function to the backlight panel. A specific image block of the touch display panel corresponds to one or more backlight units (backlight group) of the backlight panel. In some embodiments, when the display system operates in a specific mode, the control circuit may increase the brightness level of the backlight group corresponding to the specific image block by adjusting the backlight control data. In other embodiments, when the display system operates in a specific mode, the control circuit may make the brightness level of the backlight group corresponding to the specific image block blink by adjusting the backlight control data. Based on this, the control circuit may utilize a brightness level enhancement mode of the specific image block to provide the driver with intuitive visual feedback, so as to improve driving safety.

In order to make the aforementioned and other features and advantages of the disclosure more comprehensible, several embodiments accompanied with figures are described in detail below.

### BRIEF DESCRIPTION OF THE DRAWINGS

FIG. 1 is a schematic diagram of a circuit block of a vehicle display system according to an embodiment of the disclosure.

FIG. 2 is a circuit block schematic diagram of a control circuit according to an embodiment of the disclosure.

FIG. 3 is a schematic flowchart of a backlight control method according to an embodiment of the disclosure.

FIG. 4 is a schematic diagram of a display screen of a touch display panel according to an embodiment of the disclosure.

FIG. 5 is a schematic diagram of different backlight units of a backlight panel according to an embodiment of the disclosure.

FIG. 6 is a circuit block schematic diagram of a control circuit according to another embodiment of the disclosure.

FIG. 7 is a circuit block schematic diagram of a vehicle display system according to another embodiment of the disclosure.

FIG. 8 is a circuit block schematic diagram of a vehicle display system according to yet another embodiment of the disclosure.

FIG. 9 is a schematic flowchart of a backlight control method according to another embodiment of the disclosure.

### DESCRIPTION OF THE EMBODIMENTS

The term "couple (or connect)" used throughout this specification (including the claims) may refer to any direct or indirect connection means. For example, if the text describes that a first device is coupled (or connected) to a second device, it should be interpreted that the first device may be directly connected to the second device, or the first device may be indirectly connected to the second device through other devices or some connection means. Terms “first,” “second” and the like mentioned in the full text (including the claims) of the specification of this application are used only to name the elements or to distinguish different embodiments or scopes and are not intended to limit the upper or lower limit of the number of the elements, nor is it intended to limit the order of the elements. In addition, wherever possible,

elements/components/steps using the same reference numerals in the drawings and embodiments represent the same or similar parts. Elements/components/steps using the same reference numerals or the same terms in different embodiments may refer to related descriptions. It should be understood that the features of the following embodiments may be combined with each other. For example, the features of the second embodiment may be combined with the features of the first embodiment. Those having ordinary skill in the art may select appropriate feature combinations according to actual design requirements.

When a driver uses a touch screen, such as a central information display in a vehicle, a conventional touch display panel has no visual feedback to inform the driver of whether a visual button shown on the touch display panel is pressed successfully or not, and if the driver cannot immediately knows whether the target function corresponding to the button has been activated or not, the driver may need to look at the touch screen rather than pay attention to the traffic conditions, which may increase the driving risks. The display systems described in the following embodiments implement a touch-controlled brightness enhancement function and a brightness enhancement function without touch control as an alternative, under the in-vehicle screen using a local dimming control architecture in its backlight panel, so that the driver has intuitive visual feedback to improve safety. In the touch-controlled brightness enhancement function, through the touch position reporting, the display system of the vehicle may know the current touch position of a touch event, and the display system may know which backlight range corresponding to the touch position is in through a touch coordinate conversion, and consequently, the display system may, but not limited to, increase the brightness level of the backlight range corresponding to the touch position to the brightest level, so that the driver may clearly know they touch effectively or not based on the brightness difference. In addition, the driver may also customize which display areas of the touch screen need to be in a constant bright state in a night mode through touch control, so that the information that the driver considers important always maintains optimal visibility,

without losing notice of important information due to the low backlight brightness in the night mode.

It is noted that the embodiments of the present disclosure are not limited to be used in the vehicle display system. Any other electronic devices using touch interactive techniques may use the embodiments of the present disclosure to improve the end user experience.

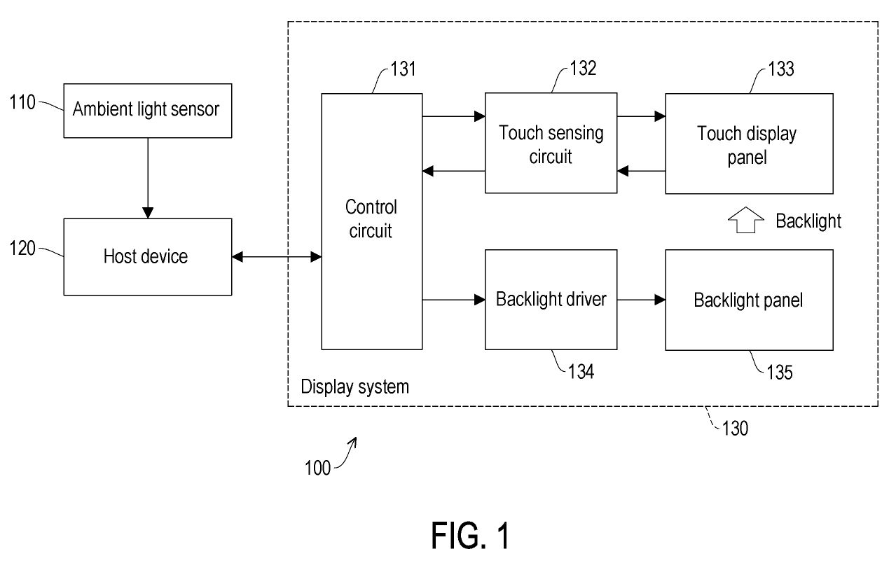

FIG. 1 is a schematic diagram of a circuit block of a display system 130 according to an embodiment of the disclosure. The display system 130 is implemented in a vehicle 100 in the embodiment. The vehicle 100 shown in FIG. 1 further includes an ambient light sensor 110 and a host device 120. The host device 120 is coupled to the ambient light sensor 110 and the display system 130. The ambient light sensor 110 may sense ambient light so as to generate ambient light information to the host device 120. The host device 120 of the vehicle 100 performs various application functions based on the ambient light information. In addition, the host device 120 may also provide the ambient light information to the display system 130.

In the embodiment shown in FIG. 1, the display system 130 includes a control circuit 131, a touch sensing circuit 132, a touch display panel 133, a backlight driver 134, and a backlight panel 135. The control circuit 131 is coupled to the host device 120. The touch sensing circuit 132 is coupled to the control circuit 131 and the touch display panel 133. The backlight driver 134 is coupled to the control circuit 131 and the backlight panel 135. The control circuit 131 is used for providing timing control signals for display control and touch control in the display system 130. The control circuit 131 is also used for generating backlight control data for backlight control in the display system 130, such that the backlight driver 134 can output diving currents with correct duty cycle to driving LEDs of the backlight panel 135. For example, the backlight panel 135 may be a direct-lit backlight panel, and the control circuit 131 controls the backlight driver 134 to perform local dimming or other backlight control on the backlight panel 135. In some application scenarios, the touch sensing circuit 132 is a touch sensing and display driving

integrated circuit, while the control circuit 131 is another integrated circuit providing timing control signals for display control and touch control. In some other application scenarios, the touch sensing circuit 132 is a touch sensing integrated circuit without display driving, while the control circuit 131 is another integrated circuit of a timing control circuit providing timing control signals integrated with a display driving circuit, called timing controller embedded driver (TED).

According to different designs, in some embodiments, the implementation of the host device 120, the control circuit 131, the touch sensing circuit 132, and/or the backlight driver 134 may be hardware circuits including analog circuit and/or digital circuits. In other embodiments, the implementation of the host device 120, the control circuit 131, the touch sensing circuit 132, and/or the backlight driver 134 may be a combination of hardware, firmware, and software (i.e., programs).

In terms of hardware, for example, the related functions of the host device 120 and the control circuit 13 may be implemented in various logic blocks, modules, and circuits in one or more hardware controllers, microcontrollers, hardware processors, microprocessors, Application-specific integrated circuits (ASICs), digital signal processors (DSPs), Field Programmable Gate Arrays (FPGAs), Central Processing Units (CPUs), and/or other processing units implemented by hardware description languages (e.g., Verilog HDL or VHDL) or other suitable programming languages.

In terms of software and/or firmware, the related functions of the host device 120, and the control circuit 131 may be implemented as programming codes. For example, the host device 120 and the control circuit 131 may be implemented using general programming languages (e.g., C, C++, or assembly language) or other suitable programming languages. The programming codes may be recorded/stored in a "non-transitory machine-readable storage medium". In some embodiments, the non-transitory machine-readable storage medium includes, for example, semiconductor memory and/or storage devices. Electronic devices (e.g., computers, CPUs,

hardware controllers, microcontrollers, hardware processors, or microprocessors) may read and execute the programming codes from the non-transitory machine-readable storage medium, thereby implementing the related functions of the host device 120 and the control circuit 131.

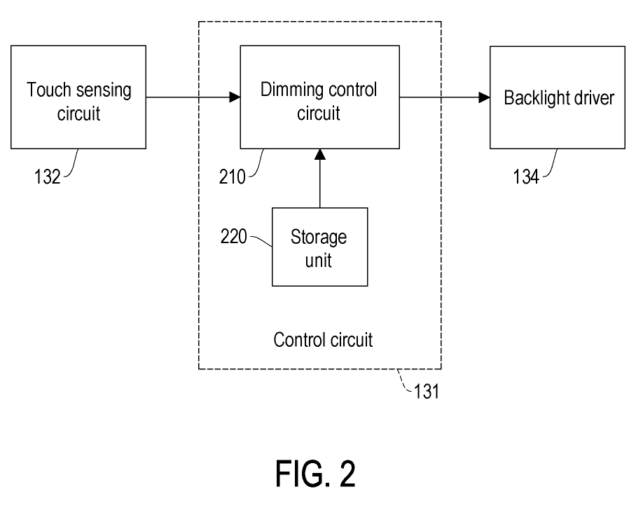

FIG. 2 is a circuit block schematic diagram of a control circuit 131 according to an embodiment of the disclosure. The control circuit 131 shown in FIG. 2 may serve as one of many implementation examples of the control circuit 131 shown in FIG. 1. The control circuit 131, the touch sensing circuit 132, and the backlight driver 134 shown in FIG. 2 may refer to the related description of FIG. 1. In the embodiment shown in FIG. 2, the control circuit 131 includes a dimming control circuit 210 and a storage unit 220. The dimming control circuit 210 is coupled to the touch sensing circuit 132, the backlight driver 134, and the storage unit 220.

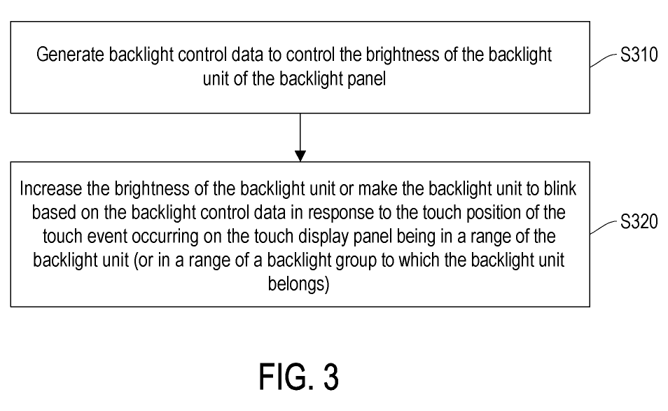

FIG. 3 is a schematic flowchart of a backlight control method according to an embodiment of the disclosure. In step S310, the dimming control circuit 210 generates backlight control data to the backlight driver 134, and the backlight driver 134 controls the brightness level of the backlight unit of the backlight panel 135 according to the backlight control data. The touch sensing circuit 132 may detect a touch event on the touch display panel 133 and then provide the touch position of the touch event to the dimming control circuit 210. In step S320, in response to the touch position of the touch event occurring on the touch display panel 133 being in a certain range of the backlight unit or in a range of a backlight group which the backlight unit belongs to, the brightness level of the backlight unit in this range is increased according to the backlight control data, or the brightness level of the backlight unit in this range is made to blink. In this embodiment, the touch-controlled brightness enhancement function may be applied no matter what mode the display system 130 is operating. As the touch positions are successively generated when the driver’s finger keeps sliding on the touch display panel 133 from one position to another, the related backlight units (which are responsible for providing backlight to the display areas where the touch positions are) are successively brighten.

In some application examples, based on the touch position of the touch event provided by the touch sensing circuit 132, the dimming control circuit 210 may determine whether the touch position is in the range of a certain backlight unit (or certain backlight units) of the backlight panel 135. In some application examples, the host device 120 informs the dimming control circuit 210 that the display system 130 is operating in a specific mode, such as a night mode or other mode. In other application examples, according to ambient light information sent from the ambient light sensor 110 to the control circuit 131, the dimming control circuit 210 determines that the display system 130 is operating in a specific mode. In this embodiment, the touch-controlled brightness enhancement function may be applied only when the dimming control circuit 210 is informed, or determines, that the display system 130 is operating in a certain specific mode. When the dimming control circuit 210 knows the display system 130 is operating in a certain specific mode, such as a night mode or other mode, in response to the touch position being in the range of the backlight unit, the dimming control circuit 210 generates backlight control data to the backlight driver 134 to control the brightness level of the backlight unit of the backlight panel 135 to be increased or to blink. For example, while the display system 130 is in the specific mode and the driver’s finger keeps sliding on the touch display panel 133 from one position to another, the brightness level of backlight units which locations are corresponding to the touch positions is increase, or made to blink.

In other application examples, each backlight group of the plurality of backlight groups of the backlight panel 135 corresponds to a specific image block of an input image displayed on the touch display panel 133 respectively. Based on actual design and application, the specific image block may be an indicator icon such as a warning icon, an application icon which is a shortcut to activate an application program, such as a telephone icon related to an application program making phone calls, or a predefined area in an input frame displayed by the touch display panel 133. For example, the telephone icon corresponds to one backlight group, a navigation

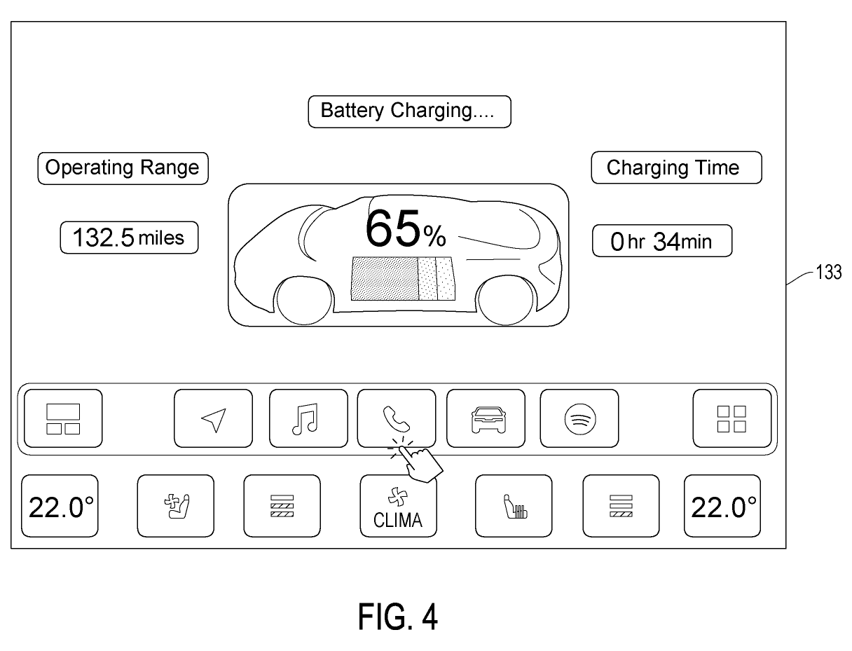

icon corresponds to another backlight group, and an area of a battery level indicator corresponds to the other backlight group. For example (but not limited to), FIG. 4 is a schematic diagram of an input image displayed on the touch display panel 133, which may be used in a central information display (CID) in a vehicle, according to an embodiment of the disclosure. The input image shown in FIG. 4 includes a plurality of indicator icons and a plurality of application icons. The operation scenario shown in FIG. 4 demonstrates that a user's finger touches the telephone icon. The touch sensing circuit 132 detects a touch event occurring on the touch display panel 133 and provides the touch position of the finger touch event to the dimming control circuit 210.

Based on the touch position of the touch event provided by the touch sensing circuit 132, the dimming control circuit 210 may determine whether the touch position of the touch display panel 133 is in the range of one of the plurality of backlight groups of the backlight panel 135. The dimming control circuit generates a plurality of backlight control data to control the brightness level of each backlight unit in these backlight groups. In some application examples, the host device 120 informs the dimming control circuit 210 that the display system 130 is operating in a specific mode, such as a night mode or other mode. In other application examples, according to the ambient light information sent from the ambient light sensor 110 to the control circuit 131, the dimming control circuit 210 determines that the display system 130 is operating in a specific mode. No matter how the dimming control circuit 210 knows that the display system 130 operates in a certain specific mode, such as a night mode or other mode, in response to that the dimming control circuit 210 determines the touch position being in the range of the backlight group, the dimming control circuit 210 generates a plurality of backlight control data to control the brightness level of each backlight unit of this backlight group to be increased or to blink.

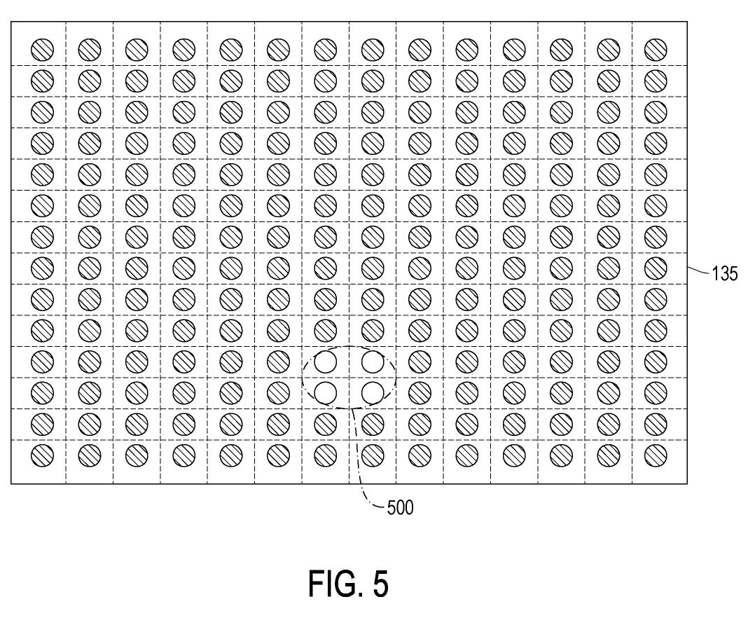

For example (but not limited to), FIG. 5 is a schematic diagram of different backlight units of the backlight panel 135 according to an embodiment of the disclosure. Each dashed box shown in FIG. 5 represents a backlight unit. Each backlight unit includes at least one light-

emitting element, for example, a light-emitting diode (LED) or other light-emitting elements. Each small circle shown in FIG. 5 represents at least one light-emitting element in a backlight unit. Referring to FIGS. 4 and 5, the driver's finger touches the telephone icon, and in response to the touch position being in the range of the backlight group 500 corresponding to the area of the telephone icon, the dimming control circuit 210 controls the backlight driver 134 through the backlight control data to increase the brightness level of each backlight unit of the backlight group 500 of the backlight panel 135, or to make each backlight unit of the backlight group 500 blink, so that the driver can immediately know that their touch is effective and they can pay attention to driving instead of keeping looking at the central information display.

The present embodiment does not limit the specific definition mechanism of the specific image blocks of the touch display panel 133. For example, in the application example shown in FIG. 2, the storage unit 220 of the control circuit 131 may pre-store a plurality of ranges of a plurality of backlight groups corresponding to a plurality of specific image blocks. After receiving the touch position of the touch event provided by the touch sensing circuit 132, the dimming control circuit 210 may look up the range of the backlight group corresponding to the touch position from the storage unit 220 based on the touch position.

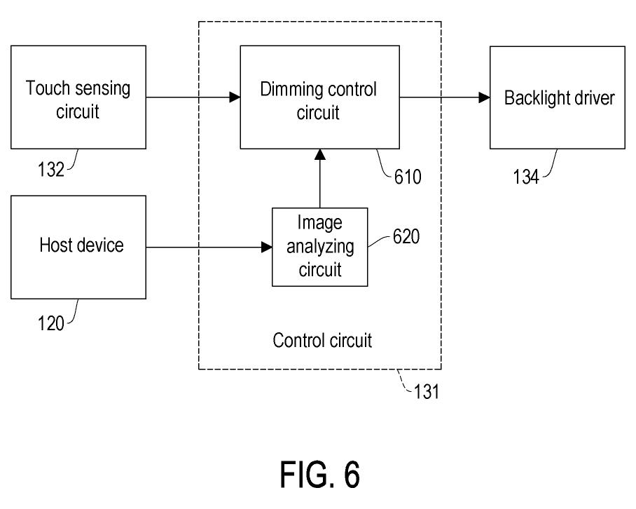

For another example, FIG. 6 is a circuit block schematic diagram of a control circuit 131 according to another embodiment of the disclosure. The control circuit 131 shown in FIG. 6 may serve as one of many implementation examples of the control circuit 131 shown in FIG. 1. The host device 120, the control circuit 131, the touch sensing circuit 132, and the backlight driver 134 shown in FIG. 6 may refer to the related description of FIG. 1. In the embodiment shown in FIG. 6, the control circuit 131 includes a dimming control circuit 610 and an image analyzing circuit 620. The dimming control circuit 610 is coupled to the touch sensing circuit 132 and the backlight driver 134, and the image analyzing circuit 620 is coupled to the host device 120 and the dimming control circuit 610. The control circuit 131 and the dimming control circuit 610 shown

in FIG. 6 may refer to the related description of the control circuit 131 and the dimming control circuit 210 shown in FIG. 2.

In the embodiment shown in FIG. 6, the image analyzing circuit 620 may perform image analysis on the input image provided by the host device 120 to obtain a plurality of backlight duty cycles of a plurality of backlight units corresponding to the input image. The image analyzing circuit 620 analyzes the plurality of backlight duty cycles of the plurality of backlight units corresponding to the input image so as to determine a plurality of ranges of a plurality of backlight groups corresponding to a plurality of specific image blocks in the input image. The backlight units which have similar duty cycles or have duty cycles in the same range may be grouped and taken as a backlight group. For example, the image analyzing circuit 620 may perform image analysis on the image (input image) shown in FIG. 4 so as to obtain the positions and ranges of the telephone icon (that is a specific image block), the navigation icon, the music icon, the battery level indicator, etc.

In summary, the control circuit 131 may apply local dimming control function to the backlight panel 135. When a touch event occurs on the touch display panel 133, the touch position of the touch event corresponds to one or more backlight units of the backlight panel 135. In some embodiments, the control circuit 131 may increase the brightness level of the one or more backlight units corresponding to the touch position by adjusting the backlight control data. In other embodiments, the control circuit 131 may make the brightness level of the one or more backlight units corresponding to the touch position to blink by adjusting the backlight control data. Based on this, the control circuit 131 may utilize the touch-controlled brightness enhancement function to provide the driver with intuitive visual feedback to enhance driving safety.

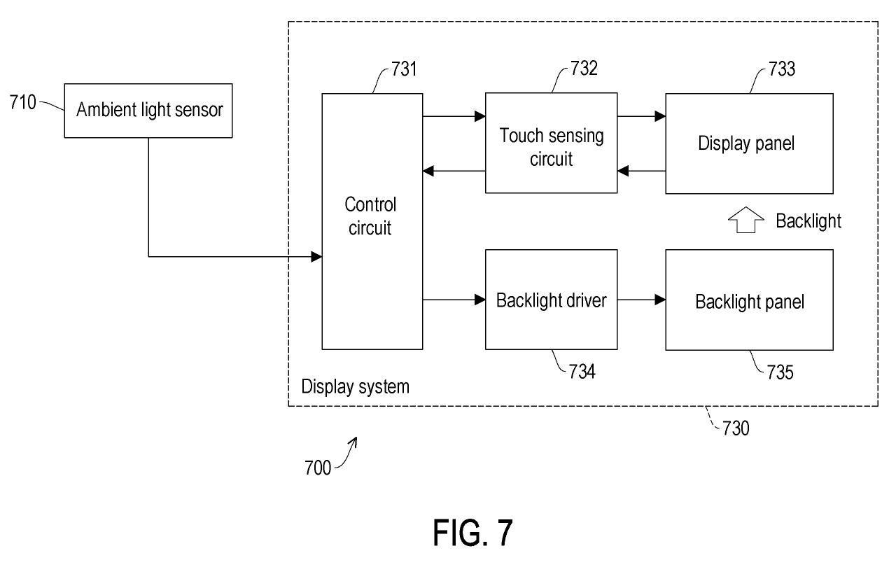

FIG. 7 is a circuit block schematic diagram of a display system 730 of a vehicle 700 according to another embodiment of the disclosure. The vehicle 700 shown in FIG. 7 includes an ambient light sensor 710 and a display system 730, and the display system 730 includes a

control circuit 731, a touch sensing circuit 732, a touch display panel 733, a backlight driver 734, and a backlight panel 735. The ambient light sensor 710 is coupled to the control circuit 731. The control circuit 731, the touch sensing circuit 732, the touch display panel 733, the backlight driver 734, and the backlight panel 735 shown in FIG. 7 may refer to the related descriptions of the control circuit 131, the touch sensing circuit 132, the touch display panel 133, the backlight driver 134, and the backlight panel 135 shown in FIG. 1 and be analogized accordingly. The ambient light sensor 710 may sense ambient light and output ambient light information to the control circuit 731. Different from that the control circuit 131 receives ambient light information through the host device 120, the control circuit 731 in FIG. 7 receives ambient light information with being through a host device. According to the ambient light information sent from the ambient light sensor 710 to the control circuit 731, the dimming control circuit of the control circuit 731 determines that the display system 730 is operating in a specific mode, such as a night mode or other mode.

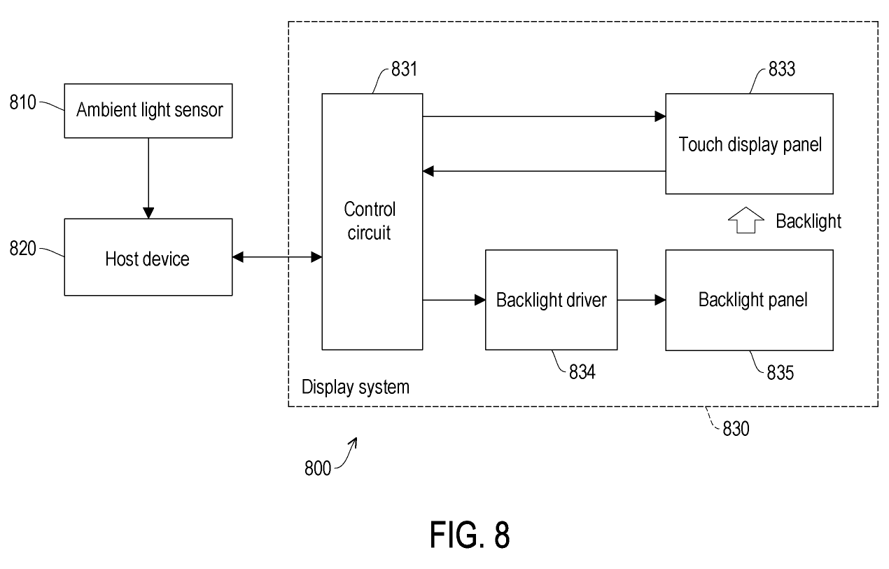

FIG. 8 is a circuit block schematic diagram of a display system 830 of a vehicle 800 according to yet another embodiment of the disclosure. The vehicle 800 shown in FIG. 8 includes an ambient light sensor 810, a host device 820, and a display system 830. The host device 820 is coupled to the ambient light sensor 810 and the display system 830. In the embodiment shown in FIG. 8, the vehicle display system 830 includes a control circuit 831, a touch display panel 833, a backlight driver 834, and a backlight panel 835. Different from the control circuit 131 illustrated in FIG. 1, the control circuit 831 may an integrated circuit of a timing control circuit integrated with a touch sensing and display driving circuit. The ambient light sensor 810, the host device 820, the touch display panel 833, the backlight driver 834, and the backlight panel 835 shown in FIG. 8 may refer to the related descriptions of the ambient light sensor 110, the host device 120, the touch display panel 133, the backlight driver 134, and the backlight panel 135 shown in FIG. 1 and be analogized accordingly.

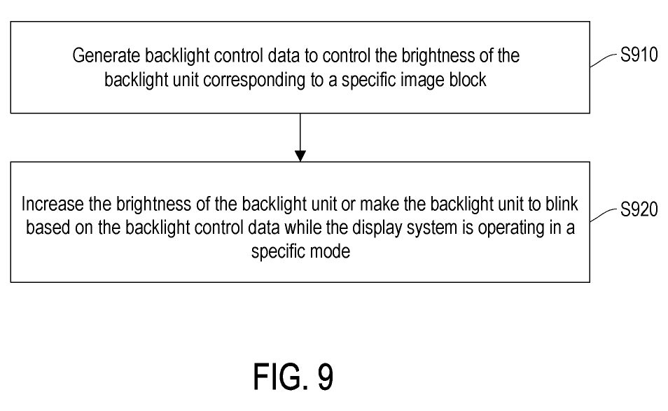

FIG. 9 is a schematic flowchart of a backlight control method according to another embodiment of the disclosure. The backlight control method of FIG. 9 realizes a brightness enhancement function which is enabled without relying on touch control and can also be used in the control circuit of the display system illustrated in FIGS. 1, 7 and 8. In step S910, the dimming control circuit generates backlight control data to the backlight driver, and the backlight driver controls the brightness level of the backlight unit of the backlight panel based on the backlight control data. The backlight unit belongs to a backlight group including a plurality of backlight units (for example, the backlight group 500 shown in FIG. 5), and a backlight group of the backlight panel corresponds to a specific image block of the touch display panel (for example, the telephone icon shown in FIG. 4). In step S920, when the control circuit knows (no matter how it does) that the display system operates in a specific mode, such as a night mode or other mode in a vehicle, the brightness level of the backlight unit is increased or made to blink according to the backlight control data.

In some application examples, the host device may inform the dimming control circuit in the control circuit that the display system is operating in the specific mode.

In some application examples, according to the ambient light information sent from the ambient light sensor to the control circuit, the dimming control circuit in the control circuit may determine that the display system is operating in the specific mode.

In summary, the control circuit may apply local dimming control function to the backlight panel. A specific image block of an input image displayed on the touch display panel corresponds to one or more backlight units (backlight group) of the backlight panel. In some embodiments, when the display system operates in a specific mode, such as a night mode or other mode, the control circuit may increase the brightness level of the backlight group corresponding to the specific image block by adjusting the backlight control data, in response to a touch position is in a range of the backlight group (or, no matter whether a touch event occurs or not). In other

embodiments, when the display system operates in a specific mode, such as a night mode or other mode, the control circuit may make the brightness level of the backlight group corresponding to the specific image block blink by adjusting the backlight control data, in response to a touch position is in a range of the backlight group (or, no matter whether a touch event occurs or not). Based on these brightness enhancement functions with/without touch control, an end user of the display system, e.g., a car driver, can get an intuitive visual feedback to their touch action as fast as possible and can pay more attention to the traffic conditions, so as to improve driving safety.

Although the disclosure has been disclosed above with embodiments, it is not intended to limit the disclosure. Any person with ordinary knowledge in the technical field may make some modifications and refinements without departing from the spirit and scope of the disclosure. Therefore, the protection scope of the disclosure shall be defined by the appended claims.

What is claimed is:

1. A control circuit for backlight control in a display system, comprising:
a dimming control circuit, configured to generate backlight control data to control a brightness level of a backlight unit of a backlight panel of the display system, wherein
the brightness level of the backlight unit is increased or is made to blink based on the backlight control data in response to a touch position of a touch event occurring on a touch display panel of the display system being in a range of the backlight unit or in a range of a backlight group which the backlight unit belongs to.

2. The control circuit according to claim 1, wherein the dimming control circuit generates the backlight control data, and
the backlight control data controls the brightness level of the backlight unit to be increased or to blink in response to the touch position being in the range of the backlight unit while the display system is operating in a specific mode.

3. The control circuit according to claim 1, wherein the dimming control circuit generates a plurality of backlight control data, and
the backlight control data control the brightness level of each backlight unit of the backlight group to be increased or to blink in response to the touch position being in the range of the backlight group while the display system is operating in a specific mode.

4. The control circuit according to claim 3, wherein the dimming control circuit is further configured to:
determine whether the touch position is in the range of one of a plurality of backlight groups, wherein each backlight group of the plurality of backlight groups corresponds to a specific image block respectively; and
generate a plurality of backlight control data that control a brightness level of each backlight unit in the backlight group.

5. The control circuit according to claim 4, wherein the specific image block is an indicator icon, an application icon, or a predefined area in an input frame displayed by the touch display panel.

6. The control circuit according to claim 4, further comprising:
a storage unit for pre-storing a plurality of ranges of the plurality of backlight groups corresponding to a plurality of specific image blocks.

7. The control circuit according to claim 4, further comprising:
an image analyzing circuit configured to:
perform image analysis on an input image to obtain a plurality of backlight duty cycles of a plurality of backlight units corresponding to the input image; and
analyze the plurality of backlight duty cycles of the plurality of backlight units corresponding to the input image to determine a plurality of ranges of the plurality of backlight groups corresponding to a plurality of specific image blocks in the input image.

8. The control circuit according to claim 2, wherein a host device informs the dimming control circuit that the display system is operating in the specific mode.

9. The control circuit according to claim 2, wherein the dimming control circuit determines that the display system is operating in the specific mode according to ambient light information sent from an ambient light sensor to the control circuit.

10. The control circuit according to claim 1, further comprising:
a touch sensing circuit, configured to determine the touch position where the touch event occurs on the touch display panel of the display system.

11. A backlight control method, comprising:
generating, by a dimming control circuit of a control circuit for backlight control in a display system, backlight control data to control a brightness level of a backlight unit of a backlight panel of the display system; and
increasing the brightness level of the backlight unit or making the backlight unit to blink according to the backlight control data in response to a touch position of a touch event occurring on a touch display panel of the display system being in a range of the backlight unit or in range of a backlight group which the backlight unit belongs to.

12. The backlight control method according to claim 11, further comprising:
generating, by the dimming control circuit, the backlight control data to control the brightness level of the backlight unit to increase or to make the backlight unit to blink in response to the touch position being in the range of the backlight unit while the display system is operating in a specific mode.

13. The backlight control method according to claim 11, further comprising:
generating, by the dimming control circuit, a plurality of backlight control data to control the brightness level of each backlight unit of the backlight group to increase or to make the backlight unit to blink in response to the touch position being in the range of the backlight group while the display system is operating in a specific mode.

14. The backlight control method according to claim 13, further comprising:
determining, by the dimming control circuit, whether the touch position is in the range of one of a plurality of backlight groups, wherein each backlight group of the plurality of backlight groups corresponds to a specific image block respectively; and
generating, by the dimming control circuit, a plurality of backlight control data to control a brightness level of each backlight unit in the backlight group.

15. The backlight control method according to claim 14, wherein the specific image block is an indicator icon, an application icon, or a predefined area in an input frame displayed by the touch display panel.

16. The backlight control method according to claim 14, further comprising:
pre-storing, by a storage unit of the control circuit, a plurality of ranges of the plurality of backlight groups corresponding to a plurality of specific image blocks.

17. The backlight control method according to claim 14, further comprising:
performing, by an image analyzing circuit of the control circuit, image analysis on an input image to obtain a plurality of backlight duty cycles of a plurality of backlight units corresponding to the input image; and
analyzing, by the image analyzing circuit, the plurality of backlight duty cycles of the plurality of backlight units corresponding to the input image to determine a plurality of ranges of the plurality of backlight groups corresponding to a plurality of specific image blocks in the input image.

18. The backlight control method according to claim 12, further comprising:
informing, by a host device, the dimming control circuit that the display system is operating in the specific mode.

19. The backlight control method according to claim 12, further comprising:
determining, by the dimming control circuit, that the display system is operating in the specific mode according to ambient light information sent from an ambient light sensor to the control circuit.

20. The backlight control method according to claim 11, further comprising:
determining, by a touch sensing circuit of the control circuit, the touch position where the touch event occurs on the touch display panel of the display system.

21. A display system, comprising:
a touch display panel;
a backlight panel;
a backlight driver; and
a control circuit for backlight control in the display system, wherein the control circuit comprises a dimming control circuit, the dimming control circuit is configured to generate backlight control data to control a brightness level of a backlight unit of the backlight panel, and
the brightness level of the backlight unit is increased or is made to blink based on the backlight control data in response to a touch position of a touch event occurring on a touch display panel being in a range of the backlight unit or in a range of a backlight group which the backlight unit belongs to.

22. The display system according to claim 21, wherein the dimming control circuit generates the backlight control data, and
the backlight control data controls the brightness level of the backlight unit to be increased or to blink in response to the touch position being in the range of the backlight unit while the display system is operating in a specific mode.

23. The display system according to claim 21, wherein the dimming control circuit generates a plurality of backlight control data, and
the backlight control data control the brightness level of each backlight unit of the backlight group to be increased or to blink in response to the touch position being in the range of the backlight group while the display system is operating in a specific mode.

24. The display system according to claim 23, wherein the dimming control circuit is further configured to:
determine whether the touch position is in the range of one of a plurality of backlight groups, wherein each backlight group of the plurality of backlight groups corresponds to a specific image block respectively; and
generate a plurality of backlight control data that control a brightness level of each backlight unit in the backlight group.

25. The display system according to claim 24, wherein the specific image block is an indicator icon, an application icon, or a predefined area in an input frame displayed by the touch display panel.

26. The display system according to claim 24, wherein the control circuit further comprises:
a storage unit for pre-storing a plurality of ranges of the plurality of backlight groups corresponding to a plurality of specific image blocks.

27. The display system according to claim 24, wherein the control circuit further comprises:
an image analyzing circuit configured to:
perform image analysis on an input image to obtain a plurality of backlight duty cycles of a plurality of backlight units corresponding to the input image; and
analyze the plurality of backlight duty cycles of the plurality of backlight units corresponding to the input image to determine a plurality of ranges of the plurality of backlight groups corresponding to a plurality of specific image blocks in the input image.

28. The display system according to claim 22, wherein a host device informs the dimming control circuit that the display system is operating in the specific mode.

29. The display system according to claim 22, wherein the dimming control circuit determines that the display system is operating in the specific mode according to ambient light information sent from an ambient light sensor to the control circuit.

30. The display system according to claim 21, wherein the control circuit further comprises:
a touch sensing circuit, configured to determine the touch position where the touch event occurs on the touch display panel of the display system.

31. The display system according to claim 30, wherein the control circuit and the touch sensing circuit are integrated in an integrated circuit.

32. A control circuit for backlight control in a display system, comprising:
a dimming control circuit, configured to generate backlight control data to control a brightness level of a backlight unit of a backlight panel of the display system, wherein the backlight unit belongs to a backlight group comprising a plurality of backlight units, and the backlight group corresponds to a specific image block, and
the brightness level of the backlight unit is increased or is made to blink based on the backlight control data while the display system is operating in a specific mode.

33. The control circuit according to claim 32, wherein a host device informs the dimming control circuit that the display system is operating in the specific mode.

34. The control circuit according to claim 32, wherein the dimming control circuit determines that the display system is operating in the specific mode according to ambient light information sent from an ambient light sensor to the control circuit.

35. A backlight control method, comprising:
generating, by a dimming control circuit of a control circuit for backlight control in a vehicle display system, backlight control data to control a brightness level of a backlight unit of a backlight panel of the display system, wherein the backlight unit belongs to a backlight group comprising a plurality of backlight units, and the backlight group corresponds to a specific image block; and
increasing the brightness level of the backlight unit or making the backlight unit to blink based on the backlight control data while the display system is operating in a specific mode.

36. The backlight control method according to claim 35, further comprising:
informing, by a host device, the dimming control circuit that the display system is operating in the specific mode.

37. The backlight control method according to claim 35, further comprising:
determining, by the dimming control circuit, that the display system is operating in the specific mode according to ambient light information sent from an ambient light sensor to the control circuit.

38. A display system, comprising:
a touch display panel;
a backlight panel;
a backlight driver; and
a control circuit for backlight control in the display system, wherein the control circuit comprises a dimming control circuit, the dimming control circuit is configured to generate backlight control data to control a brightness level of a backlight unit of a backlight panel of the display system, the backlight unit belongs to a backlight group comprising a plurality of backlight units, the backlight group corresponds to a specific image block, and
the brightness level of the backlight unit is increased or is made to blink based on the backlight control data while the vehicle display system is operating in a specific mode.

39. The display system according to claim 38, wherein a host device informs the dimming control circuit that the display system is operating in the specific mode.

40. The display system according to claim 38, wherein the dimming control circuit determines that the display system is operating in the specific mode according to ambient light information sent from an ambient light sensor to the control circuit.
